(19) United States
(12) Patent Application Publication
(10) Pub. No.: US 2011/0120583 A1
(43) Pub. Date: May 26, 2011

(54) PIPE WITH SHEATH HAVING REDUCED PERMEABILITY TO ACID COMPOUNDS

(76) Inventors: Alain Coutarel, Mont Saint Aignan (FR); Frédéric Demanze, Chaville (FR); Serge Gonzalez, Decines (FR); Xavier Lefebvre, Conflans-Sainte-Honorine (FR); Marie-Hélène Klopffer, Montigny-Le-Bretonneux (FR); Emmanuel Vinciguerra, Corse (FR); Bernard Dewimille, Corbeil Essonne (FR)

(21) Appl. No.: 12/997,933

(22) PCT Filed: Jun. 16, 2009
(86) PCT No.: PCT/FR09/00719

§ 371 Date: Feb. 9, 2011

(30) Foreign Application Priority Data
Jun. 18, 2008 (FR) 0803413

(51) Int. Cl. F16L 11/04; B32B 27/18; F16L 11/14

(52) U.S. Cl. 138/138

(57) ABSTRACT

The pipe is intended for carrying a petroleum effluent comprising at least one of the acid compounds CO₂ and H₂S.

The pipe comprises at least one metal element (3, 5) and a tubular sheath made of a polymer material (2, 4), the metal element being provided outside the sheath. The sheath consists of a mixture of a polymer material with a predetermined amount of products chemically active with said acid compounds so as to irreversibly neutralize the corrosive effects of said compounds and to limit the corrosive effects on said metal elements.

The pipe is characterized in that the chemically active products are incorporated into the sheath in form of particles of specific surface area above 5 m²/g.

### CROSS-REFERENCE TO RELATED APPLICATIONS

The present application is a 35 U.S.C. '371 national phase conversion of PCT/FR2009/000719, filed Jun. 16, 2009, which claims priority of French Application No. 0803413 filed Jun. 18, 2008, the contents of which are incorporated by reference herein. The PCT International Application was published in the English language.

### FIELD OF THE INVENTION

The present invention relates to pipes for carrying a petroleum fluid comprising acid compounds such as hydrogen sulfide and carbon dioxide.

The invention notably applies to hydrocarbons carried in pipes likely to convey high pressures, above 100 bars, and high temperatures, above 70° C. or even 100° C. fluids, over long periods of time, i.e. several years. The pipes are notably used for offshore oil drilling.

The pipes can be metal tubes lined with a tube made of a polymer material. The pipes can also be flexible pipes comprising of a superposition of sheaths made of a polymer material and of several layers of helically wound wires.

### BACKGROUND OF THE INVENTION

When a petroleum effluent is transported at high pressure and high temperature, acid compounds such as CO₂ and H₂S tend to migrate through the polymer lining sheath until they reach the metal parts of the pipe and cause accelerated corrosion. Corrosion involves risks for the mechanical integrity of the pipe that is subjected to great stress due to the high pressures of the petroleum effluent and to the marine environment.

Document EP-844,429 aims to incorporate into the polymer material sheath products that are chemically active with acid compounds (CO₂ and/or H₂S) so as to irreversibly neutralize the corrosive effects of the acid compounds and to prevent corrosive effects on the metal parts of the pipe.

The present invention aims to improve the teaching of document EP-844,429 by providing solutions allowing to substantially increase the neutralizing effect of the products chemically active with the acid compounds.

### SUMMARY OF THE INVENTION

In general terms, the present invention relates to a pipe for carrying a petroleum effluent comprising at least one of the acid compounds CO₂ and H₂S. The pipe comprises at least one metal element and a tubular sheath made of a polymer material, the metal element being provided outside the sheath. The sheath includes a mixture of a polymer material with a predetermined amount of products chemically active with the acid compounds so as to irreversibly neutralize the corrosive effects of the compounds and to limit the corrosive effects on the metal elements. The pipe is characterized in that the chemically active products are incorporated into the sheath in the form of particles of specific surface area above 5 m²/g.

According to the invention, the chemically active products can be incorporated into the sheath in form of particles of grain size above 0.02 μm.

The chemically active products can be selected among metal oxides selected from the group made up of Fe₂O₃, PbO, ZnO, NiO, CoO, CdO, CuO, SnO₂, MoO₃, Fe₃O₄, Ag₂O, CrO₂, CrO₃, Cr₂O₃, TiO, TiO₂ and Ti₂O₃, and among the alkaline and alkaline-earth oxides selected from CaO, Ca(OH)₂ and MgO.

The chemically active products can also be selected from among metal carbonates, metal chlorides, the hydrated forms of metal carbonates and metal chlorides, the hydroxylated forms of metal carbonates and metal chlorides, alkaline carbonates, alkaline-earth carbonates, alkaline chlorides, alkaline-earth chlorides, the hydrated forms of alkaline carbonates, alkaline-earth carbonates, alkaline chlorides, alkaline-earth chlorides and the hydroxylated forms of alkaline carbonates, alkaline-earth carbonates, alkaline chlorides, alkaline-earth chlorides.

The sheath can also comprise fillers of lamellar shape having a shape coefficient above 20, the mass concentration of the lamellar fillers in the sheath being 10% maximum.

The sheath can furthermore comprise adsorbent fillers that trap the acid compounds, the adsorbent fillers being selected from among activated charcoals, zeolites and aluminas.

The sheath can comprise additives intended to improve the mechanical properties of the sheath, the additives being selected from among poly(ethylene-octene), poly(ethylene-propylene), poly(ethylene-butene) and poly(styrene/ethylene-butylene/styrene).

The chemically active products can be subjected to a chemical surface treatment with silanes.

The sheath can comprise maleic anhydride grafted polyolefins.

According to the invention, the sheath can comprise at least two layers, a first layer comprising a first polymer material and a second layer comprising a second polymer material containing the predetermined amount of chemically active products. The first layer can also comprise lamellar-shaped fillers having a shape coefficient above 20, the mass concentration of the lamellar fillers in the first layer being 10% maximum. A coating can be provided between the two layers, wherein the coating contains an amount of the chemically active products.

Alternatively, the predetermined amount of chemically active products can be distributed throughout the thickness of the sheath.

### BRIEF DESCRIPTION OF THE FIGURES

Other features and advantages of the invention will be clear from reading the description hereafter, with reference to the accompanying figures wherein:

FIG. 1 diagrammatically shows a flexible pipe,

FIG. 2 diagrammatically shows a rigid pipe, and

FIG. 3 shows in detail a multi-layer polymer sheath.

### DETAILED DESCRIPTION

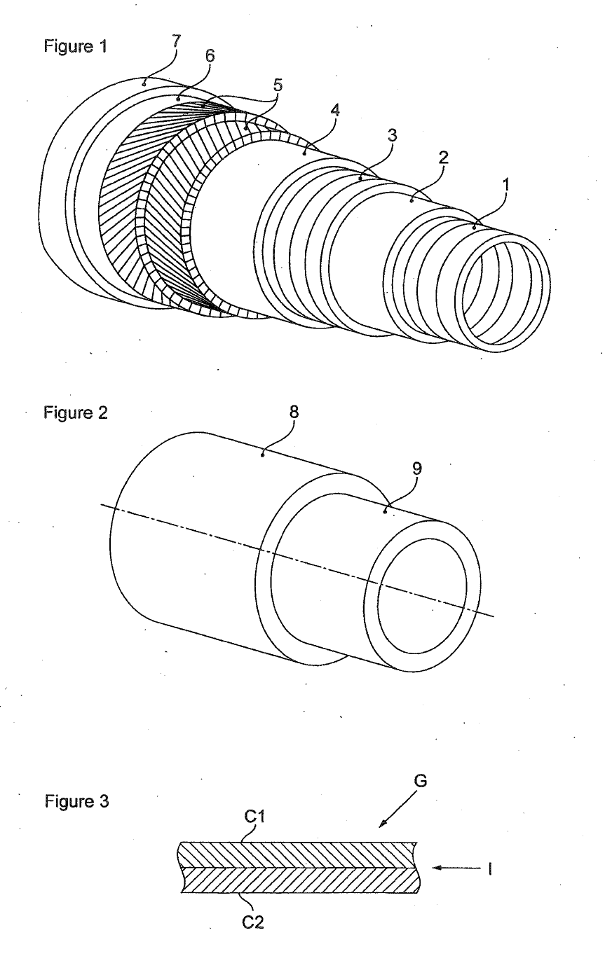

The flexible pipe shown in FIG. 1 is made up of several layers described hereafter from the inside to the outside of the pipe.

Carcass 1 comprises a metal band wound in a helix with a short pitch. It is designed for collapse strength under the effect of the external pressure applied to the pipe. The metal band can be made from a deformed strip or a wire, with each spire being clamped to the adjacent spires.

Sealing sheaths 2 and 4 are made by extrusion of a polymer material generally selected from among fluorinated polymers, polyolefins and polyamides.

Pressure vault 3 between the sheaths 2 and 4 is made of clamped or interlocking wires and provides resistance to the internal pressure in the pipe.

Tensile armor plies 5 comprise wires helically wound at angles ranging between 20° and 55°. The plies are held in position by strip 6.

Polymer sheath 7 forms external protection of the pipe.

According to the invention, at least one of the sealing sheaths 2 and 4 comprises fillers that are chemically active with CO₂ and/or H₂S.

The pipe shown in FIG. 1 is of rough bore type, i.e. the fluid circulating in the pipe is in contact with carcass 1.

Alternatively, the pipe can be of smooth bore type. In this case, the pipe shown in FIG. 1 would comprise no carcass 1. Then polymer sheath 2 is directly in contact with the fluid circulating in the pipe.

The pipe diagrammatically shown in FIG. 2 comprises a metal tube 8 whose inner surface is lined with a continuous sealing sheath 9 made of a polymer material.

According to the invention, sheath 9 comprises fillers chemically active with CO₂ and/or H₂S.

According to the invention, the sealing sheaths are made from a mixture of a polymer material and of fillers made of agents neutralizing acid compounds such as CO₂ and H₂S.

The mixture is prepared at a higher temperature than the melting temperature of the polymer material, during sheath extrusion operations. The neutralizing agent fillers may be distributed throughout the thickness of the polymer sealing sheath.

Considering the domain of the invention, i.e. rigid or flexible oil pipes, the polymer material is preferably selected from among polyolefins, cross-linked or not, for example polyethylene (PE) or polypropylene (PP), polyamides, for example polyamide 11 (PA-11) or polyamide 12 (PA-12), fluorinated polymers, for example polyvinylidene fluoride (PVDF), polysulfides, for example polyphenylene sulfide (PPS), polyurethanes (PU), polyesters, polyacetals, polyethers, for example polyethersulfone (PES), polyetheretherketone (PEEK) and rubbers such as butyl rubber.

The agents intended to neutralize the acid compounds are selected from among metal oxides (Fe₂O₃, PbO, ZnO, NiO, CoO, CdO, CuO, SnO₂, MoO₃, Fe₃O₄, Ag₂O, CrO₂, CrO₃, Cr₂O₃, TiO, TiO₂ and Ti₂O₃) or alkaline or alkaline-earth oxides (CaO, Ca(OH)₂, MgO), or compounds comprising amine functions such as polyamines and polyethylene polyamines. A single type of neutralizing agent can be used. It is also possible to use a combination of different neutralizing agents, for example a combination of several metal oxides, a combination of metal oxides with alkaline or alkaline-earth oxides.

The chemically active products can also be selected from among metal carbonates (ZnCO₃ for example) or metal chlorides (ZnCl₂ for example), as well as the hydrated and/or hydroxylated forms of metal carbonates and metal chlorides (2ZnCO₃.3H₂O, Zn(OH)₂, Zn₅(CO₃)₂(OH)₆ or [Zn(OH)₂]₃.(ZnCO₃)₂) for example). The chemically active products can also be selected from among alkaline carbonates, alkaline-earth carbonates, alkaline chlorides and alkaline-earth chlorides (Na₂CO₃ or CaCO₃ for example), as well as the hydrated and/or hydroxylated forms of alkaline carbonates, alkaline-earth carbonates, alkaline chlorides and alkaline-earth chlorides.

For the aforementioned neutralizing agents, the reaction principle consists in switching from oxide, carbonate, chlorine derivatives (possibly in hydrated and/or hydroxylated form) to sulfur (in case of a reaction with H₂S) or carbonate (in case of a reaction with CO₂) derivatives. Of course, in cases where only CO₂ is present, the carbonate forms of the metal derivatives, alkaline derivatives and alkaline-earth derivatives are not selected.

According to the invention, the mass proportion of agents neutralizing the acid compounds can range between 10 and 50 mass %. In fact, for mass concentrations below 10%, the thickness of sheath 9 required to obtain an acceptable efficiency could be too great to allow insertion thereof in the flexible pipe. For neutralizing agent mass concentrations above 50%, the mechanical strength properties of sheath 9 could be incompatible with the application.

According to the invention, neutralizing agent fillers having a specific surface area above 5 m²/g, preferably at least above 20 m²/g, are selected. Preferably, the specific surface area of the neutralizing agent can be below 50 m²/g. In fact, the inventors have discovered that the specific surface area of the fillers is critical for determining the corrosion strength of the metal parts of the pipe. For a given mass fraction of neutralizing agent fillers in the matrix, the efficiency of the filler is all the higher as its specific surface area is large. In fact, the efficiency of a reactive filler in a polymer sheath is related to the mass yield of the filler, i.e. the number of moles of reactive filler that are going to react with the acid compounds, and to the time required for passage of one mole of acid compound through the filled polymer sheath. It has been shown (see notably the examples given hereafter) that the larger the specific surface area of the reactive filler, the more there are acid-filler reactions at the surface of the filler, and the longer the time required for passage of the active molecules through the filled polymer sheath. This corresponds, for a given mass fraction of reactive fillers, to a higher efficiency of said filler.

It can be noted that the mass yields obtained are always strictly below 100%. Unreacted reactive filler parts therefore remain, and thus acid compounds manage to pass through the thickness of the filled polymer sheath although all the fillers have not reacted.

Besides, within the scope of the production of flexible pipes, one aims to reduce the volume and the weight of the structures. The efficiency of sheath 9 is all the higher as the volume and the weight thereof are lower, and therefore the thickness thereof is low. The density of the organic polymers used within the scope of the invention is relatively low and it generally ranges between 0.9 g/cm³ and 1.8 g/cm³. The importance of the amount of agents neutralizing the acid compounds, whose density can be above 5 g/cm³, clearly appears within the scope of the invention since it influences the efficiency and therefore the thickness of sheath 9. Consequently, the present invention aims to optimize the size and the accessible surface area for an agent neutralizing the acid compounds so as to best use the neutralization capacity of said agent dispersed in the sheath.

A standard method of measuring the specific surface area is based on the physical adsorption of nitrogen on the surface of a solid (Brunauer, Emmett, Teller BET method).

In order to illustrate the importance of the size and of the accessible surface area of the filler(s), mixtures of polyethylene 3802S (produced by TOTAL Petrochemical) with fillers of various grain sizes, of variable shape factors and different specific surface areas, have been prepared by means of a HAAKE type mixer. Mixing is carried out at 170° C. with a blade speed of 32 rpm for 10 minutes. Shaping of the mixture in form of 7.5 mm-thick plates is performed at 170° C. for one minute at a pressure of 200 bars, by means of a platen press. In order to assess the efficiency of the active membrane, a circular sample of 12 to 24 mm in diameter is cut out using a punch, then subjected to a given pressure of pure H₂S in a stainless steel reactor for a predetermined time. At the end of the experiment, the cylindrical sample is divided into two equal parts. A sulfur detection analysis is carried out on the edge of the sample using an electron probe microanalyser. The efficiency of the active membrane is directly related to the progress and to the shape of the sulfur front in the depth of the sample.

### Influences of the Grain Size and of the Specific Surface Area

The comparative examples of Table 1 are achieved with PE3802S containing 29 wt. % zinc oxide, and they illustrate the influence of the grain size on the measurement of the sulfur front progress in the depth of the sample.

TABLE 1

| | Zinc oxide | | | Relative sulfur |
|---|---|---|---|---|
| Exam- | grain size | P H₂S | Time | front progress |
| ple | (microns) | (bar) | (h) | (%) |
| 1 | 0.84 | 1 | 336 | 100 |
| 2 | 0.21 | 1 | 336 | 90.2 |
| 3 | 0.11 | 1 | 336 | 83.4 |

Examples 1 to 3 clearly show that, with a constant mass fraction of reactive fillers, a smaller grain size allows to limit the progress of the sulfur front in the sample. Nanometric reactive fillers, i.e. whose grain size is below 1 μm, are preferably used.

The comparative examples of Table 2 are achieved with PE3802S containing 29 wt. % zinc oxide, and they illustrate the influence of the specific surface area on the measurement of the sulfur front progress in the depth of the sample.

TABLE 2

| | Zinc oxide | | | Relative sulfur |
|---|---|---|---|---|
| Exam- | specific surface | P H₂S | Time | front progress |
| ple | area (m²/g) | (bar) | (h) | (%) |
| 4 | 8 | 1 | 48 | 100 |
| 5 | 22 | 1 | 48 | 76.7 |
| 6 | 28 | 1 | 48 | 57 |

Examples 4 to 6 clearly show that a large specific surface area allows to limit the progress of the sulfur front within the polymer matrix and therefore delays the time when the acid compounds flow through the thickness of the polymer sheath. The present invention aims to use fillers whose specific surface area is above 5 m²/g, preferably at least above 20 m²/g.

In some cases, the mixture of polymer material and of neutralizing agent fillers can degrade during the extrusion operation: water generated by reaction between the polymer and the filler can produce, for example, degradation of the polymer through hydrolysis of the macromolecular chain. In order to limit unwanted reactions between the filler and the polymer, the filler can be encapsulated or coated. The presence of an additional layer between the polymer material and the reactive filler allows to avoid polymer matrix degradation problems by limiting the contact between the polymer and the reactive filler. However, an additional layer permeable to acid molecules is selected so as to allow better access to the reactive sites of the filler. Among the various encapsulation methods that can be used, fluidized air bed encapsulation can be selected for example: the compound neutralizing the acid compound is coated with an agent that isolates it from the polymer matrix.

Using reactive fillers in admixture with polymer materials can induce mechanical property changes and cause implementation problems upon extrusion and shaping of the polymer sheath. According to the invention, additives allowing to limit flow defects of the compositions and to improve the mechanical properties of the sheath can be added. The additives can be added when mixing the polymer material with the reactive agents, at a temperature above the melting temperature of the polymer material.

For high filler rates, it is possible to use compounds that allow to keep yield stress elongation and ultimate elongation properties, as well as Young's modulus properties compatible with the stresses undergone by oil pipes. For example, it is possible to add thermoplastic elastomers such as poly(ethylene-octene), poly(ethylene-propylene), poly(ethylene-butene) marketed by Dow under the trade name Engage™, block copolymers such as poly(styrene/ethylene-butylene/styrene) grafted or not in polyethylene in order to promote the implementation and to improve the mechanical properties of the polymer. Furthermore, Lotader type copolymers marketed by Arkema can be added to the polyamides to promote the compatibility of the neutralizing agent with the polymer matrix.

It is also possible to promote the creation of strong interfaces between the agent neutralizing the acid compounds and the polymer of the sealing sheath. Thus, the neutralizing agent can be subjected to a chemical surface treatment with silanes. Maleic anhydride grafted polyolefins can also be added to increase the filler-matrix interactions.

According to the invention, the stage of preparing and implementing the mixture of polymer material and of fillers chemically reactive with the acid compounds CO₂ and/or H₂S is important. In fact, the chemically reactive fillers are preferably distributed homogeneously in the polymer material. In fact, homogeneous distribution of the reactive fillers allows to neutralize the acid compounds over the entire surface of the sheath and avoids formation of preferential passages of acid compounds through the sheath, which would lead to a fast acid outflow from the sheath and therefore to a poor efficiency. Furthermore, an inhomogeneous local concentration of reactive fillers in the sheath could cause mechanical strength weakness in the sheath. The inventors have discovered that, below a grain size value, the distribution of the filler in the polymer matrix is no longer sufficiently homogeneous to improve the action of the filler. Consequently, according to the invention, fillers in form of aggregates whose grain size is above 0.02 μm are preferably used.

The fillers chemically active with the acid compounds can be incorporated into the base polymer either in form of dry powder or in form of a suspended solution. Incorporation can be achieved during in-situ polymerization, during the compounding stage or via the use of a master mixture.

In order to obtain a homogeneous dispersion of fillers of smaller grain size than in the polymer matrix, the surface of the reactive fillers can for example be chemically modified or dispersing agents can be added. It is also possible to modify the profiles of the extruder screw, the operating conditions such as the flow rate, the temperature, so as to obtain a correct mix. Furthermore, the mixture of polymer material with the reactive fillers can be achieved in several operations. For example, a premixture is prepared with a high reactive filler concentration. The premixture is then diluted in a subsequent stage.

In order to limit the velocity of diffusion through the polymer sheath, fillers of lamellar shape such as mica, natural or synthetic smectites (montmorillonites, laponites, saponites, bentonites) can be introduced. Fillers of lamellar shape have a plane shape, i.e. a large flat surface in relation to the thickness thereof. In general, a lamellar filler is characterized by a shape factor that gives the value of the ratio of its largest dimension to its smallest dimension (generally its thickness). According to the invention, fillers whose shape factor is above 20 and below 500 are selected. The nanometric lamellar compound particles, in low mass fraction, allow to significantly improve the properties of the polymer matrix. A mass fraction of lamellar compounds below 10% is preferably added. Besides, the lamellar compounds can comprise an intercalation agent that can intercalate and/or exfoliate the lamellas of the particles so as to completely separate the lamellas from one another in the polymer matrix. The lamellar fillers allow to reduce the permeability of the polymer sheath via a tortuosity effect. In fact, the acid compound particles have to travel a much longer path due to the presence of impermeable objects that they have to bypass. The larger the shape factor, the larger the diffusion path. Furthermore, the diffusion path increase allows to increase the probabilities of encounter of the acid compound molecules with the reactive fillers. Thus, not only do these lamellar fillers allow to slow down the diffusion of the acid compounds through the sheath, but they also allow to increase the efficiency of the reactive fillers towards the acid compounds.

It is also possible to reduce the diffusion of acid gases through the sheath using fillers that trap the acid gases reversibly, for example activated charcoal particles, zeolites or aluminas. This temporary trapping allows, on the one hand, to slow down the passage of the acid molecules in the polymer matrix and, on the other hand, to increase the probability of reaction between an acid molecule and a reactive filler. All this tends to increase the efficiency of the polymer membrane comprising reactive fillers in an irreversible manner as well as reactive fillers in a reversible manner.

According to a particular embodiment of the invention, the sealing sheath bearing reference number 2 or 4 in FIG. 1, or 9 in FIG. 2 respectively, is made of several layers.

Making a multi-layer polymer sheath allows one layer to be dedicated to the function of barrier against acid compounds, the mechanical or thermal stresses being borne by another layer.

Referring to FIG. 3, sheath G is made of two layers C1 and C2. Layers C1 and C2 are successively extruded. For example, layer C1 is extruded on a kernel, then layer C2 is extruded on layer C1 to obtain a sheath whose layer C1 is inside and layer C2 is outside. Layer C1 is made with a polymer material without neutralizing agents in order to have good mechanical and thermal strength of sheath G. Furthermore, layer C1 allows to limit the flow rate of acid compounds through sheath G. Layer C2 comprises a mixture of polymer material and of neutralizing agent fillers acting as a barrier to acid compounds. This embodiment allows to select a polymer material for layer C2 which accepts the presence of neutralizing agents. Preferably, layers C1 and C2 are made of polymer such as: fluorinated polymers, polyethylenes, polyamides. By way of example, a first layer C1 is made of Polyamide 11 and a second layer C2 of Polyethylene filled with a metal oxide such as ZnO. Layer C1 fulfils a sealing sheath function, it therefore limits the flow rate of acid gases flowing towards layer C2. On the other hand, it also acts as a thermal barrier since it limits the temperature undergone by layer C2.

Alternatively, the order of layers C1 and C2 and the nature of the polymer can be reversed.

The example described hereafter allows to illustrate the advantage provided by the use of active particles having large specific surface areas in a flexible pipe according to the invention. The pipe carries a fluid comprising H₂S at a partial pressure of 0.3 bar, the fluid being at a temperature of 60° C. The pipe comprises a two-layer sealing sheath as described with reference to FIG. 3. Layer C2 comprises 30 wt. % zinc oxides (ZnO). The thickness of layer C2 is determined in such a way that the zinc oxides are efficient over an operating time of 20 years (after 20 years, all of the ZnO has reacted with the H₂S):
when the ZnO fillers have a specific surface area of 10 m²/g, the thickness of layer C2 is estimated at 12 mm,
when the ZnO fillers have a specific surface area of 50 m²/g, the thickness of layer C2 is estimated at 6 mm.

Consequently, using chemically active agents with a large specific surface area (for example advantageously above 10 m²/g, or more advantageously above 50 m²/g) allows to limit the thickness of the sealing sheath and therefore to reduce the flexural stiffness of the pipe.

In order to reduce the permeability of sheath G and to reduce the acid compound concentrations at interface I between layers C1 and C2, according to the invention, it is possible to incorporate lamellar fillers into layer C1 (lamellar fillers having a shape factor above 20 and optionally comprising an intercalation agent, with a maximum mass fraction of inorganic particles of 10%).

In order to limit the accumulation of acid compounds at the interface between the two layers, a coating comprising chemically active products can be deposited at the interface. One of the layers, C1 or C2, is extruded and said coating filled with neutralizing agents is deposited on the outside of the layer, then the second layer is extruded on the coated layer.

The chemically active products contained in the coating can be metal, alkaline or alkaline-earth oxides, or amines. The coating can consist of a thin layer of material of the invention deposited through winding in form of a band for example.

The coating can be a paint, an organic or mineral tissue coated with the material of the invention. The coating can be deposited in liquid and dried form, such as a paint. It has to be supple in order to avoid the formation, through premature failure, of preferential passages for the acid molecules.

1) A pipe for carrying a petroleum effluent comprising at least one of the acid compounds CO₂ and H₂S, the pipe comprising at least one metal element and a tubular sheath made of a polymer material, the at least one metal element being provided outside the sheath, the sheath comprising a mixture of a polymer material with at least one product chemically active with the acid compounds to neutralize corrosive effects of the compounds and to limit corrosive effects on the at least one metal element, the chemically active product is incorporated into the sheath in a form of particles of specific surface area above 5 m²/g.

2) A pipe as claimed in claim 1, wherein the chemically active product is incorporated into the sheath in a form of particles of grain size above 0.02 μm.

3) A pipe as claimed in claim 1, wherein the chemically active product is selected from among metal oxides selected from the group consisting of Fe₂O₃, PbO, ZnO, NiO, CoO, CdO, CuO, SnO₂, MoO₃, Fe₃O₄, Ag₂O, CrO₂, CrO₃, Cr₂O₃, TiO, TiO₂ and Ti₂O₃, and from among the alkaline and alkaline-earth oxides selected from the group consisting of CaO, Ca(OH)₂ and MgO.

4) A pipe as claimed in claim 1, wherein the chemically active product is selected from the group consisting of metal carbonates, metal chlorides, the hydrated forms of metal carbonates and metal chlorides, the hydroxylated forms of metal carbonates and metal chlorides, alkaline carbonates, alkaline-earth carbonates, alkaline chlorides, alkaline-earth chlorides, the hydrated forms of alkaline carbonates, alkaline-earth carbonates, alkaline chlorides, alkaline-earth chlorides and the hydroxylated forms of alkaline carbonates, alkaline-earth carbonates, alkaline chlorides, and alkaline-earth chlorides.

5) A pipe as claimed in claim 1, wherein the sheath also comprises fillers of lamellar shape having a shape coefficient above 20, the mass concentration of said lamellar fillers in the sheath being 10% maximum.

6) A pipe as claimed in claim 1, wherein the sheath also comprises adsorbent fillers configured to trap the acid compounds, the adsorbent fillers being selected from the group consisting of activated charcoals, zeolites and aluminas.

7) A pipe as claimed in claim 1, wherein the sheath comprises additives which improve the mechanical properties of the sheath, the additives being selected from the group consisting of poly(ethylene-octene), poly(ethylene-propylene), poly(ethylene-butene) and poly(styrene/ethylene-butylene/styrene).

8) A pipe as claimed in claim 1, wherein the chemically active product has been subjected to a chemical surface treatment with silanes.

9) A pipe as claimed in claim 1, wherein the sheath comprises maleic anhydride grafted polyolefins.

10) A pipe as claimed in claim 1, wherein the sheath comprises at least two layers, including a first layer comprising a first polymer material, and a second layer comprising a second polymer material containing the chemically active products.

11) A pipe as claimed in claim 10, wherein the first layer also comprises lamellar-shaped fillers having a shape coefficient above 20, the lamellar fillers in the first layer having a mass concentration of 10% maximum.

12) A pipe as claimed in 10, further comprising a coating deposited between the two layers, the coating containing an amount of the chemically active product.

13) A pipe as claimed in claim 1, wherein the chemically active product is distributed throughout the thickness of said sheath.
